(19) United States
(12) Patent Application Publication
(10) Pub. No.: US 2007/0205229 A1
(43) Pub. Date: Sep. 6, 2007

(54) Multiple Layer Beverage Closure

(76) Inventors: William C. Schmeisser, Barrington, IL (US); Thomas C. Stoneberg, Buffalo Grove Lane, IL (US)

Correspondence Address: MIDDLETON & REUTLINGER, 2500 BROWN & WILLIAMSON TOWER, LOUISVILLE, KY, 40202, US

(21) Appl. No.: 11/382,576

(22) Filed: May 10, 2006

Related U.S. Application Data
(63) Continuation-in-part of application No. 10/941,365, filed on Sep. 15, 2004, now Pat. No. 7,143,911.
(62) Division of application No. 10/624,924, filed on Jul. 22, 2003, now Pat. No. 6,871,764.
(60) Provisional application No. 60/397,974, filed on Jul. 22, 2002.

(51) Int. Cl. B67D 3/00

(52) U.S. Cl. 222/525

(57) ABSTRACT

A closure for a container adapted to contain a liquid comprising: (a) a base adapted to be attached to an opening of a fluid container, the base including a conduit extending therethrough that is adapted to be in fluid communication with fluid contents of the fluid container when attached to the opening of the fluid container, and the base further including a spout guide defining at least a portion of the conduit and having an annular deck extending inwardly from an inner circumferential surface of the base, defining an orifice in fluid communication with the conduit; (b) a spout mounted to the spout guide for reciprocation between an open position and a closed position, the spout including a plug having a leading end adapted to allow fluid flow through the orifice when the spout is in the open position; and (c) a discrete sealing member coupled to at least one of the spout and the base, adapted to be at least partially displaced to provide a fluidic seal between at least one of the spout and the base to seal off the orifice when the spout is in the closed position.

### CROSS-REFERENCE TO RELATED APPLICATIONS

The present application is a continuation-in-part of U.S. Nonprovisional patent application Ser. No. 10/941,365 filed Sep. 15, 2004, entitled “BEVERAGE CLOSURE WITH OPEN/CLOSE SPOUT AND PROTECTED SEAL SURFACES”, which is a divisional of U.S. Nonprovisional patent application Ser. No. 10/624,924 filed Jul. 22, 2003, entitled “BEVERAGE CLOSURE WITH OPEN/CLOSE SPOUT AND PROTECTED SEAL SURFACES”, which claims priority from U.S. Provisional Patent Application Ser. No. 60/397,974 entitled “CLOSURE FOR A CONTAINER” filed on Jul. 22, 2002.

### RELATED ART

1. Field of the Invention

The present application is related to closures for fluid containers and, more specifically, to closures having an open/close type spout and plug, where at least one of the sealing surfaces within the closure includes a more resilient material molded over a more rigid material, thereby improving the performance and consistency of the closure product. This application is relevant to both push/pull type spouts and to twist open/close spouts.

2. Brief Discussion of Related Art

Prior art closures having an open/close type spout and plug typically include at least two components: a base component that attaches to the throat of a beverage container, and a spout component that is carried on the base component and is adapted to be reciprocated between an open and close position with respect to the base component by a consumer. Typically, the base component includes an opening coaxial with the throat of the beverage container and a coaxial plug extending from the opening, and the spout component includes a coaxial orifice that is in fluid communication with the opening of the base component when the spout is in its open position and that is plugged by the plug of the base component when the spout component is in its closed position. It also known to provide a plug on the spout component rather than the base component, which cooperates with an orifice on the base component.

With such closures, the base and spout components are typically molded separately from thermoplastic materials and later assembled together in an assembly operation. Furthermore, with such prior art closures, the plugs of the base or spout components extend outwardly from the component. Thus, during the molding process, the plug's sealing surface (which will seal against the corresponding sealing surface of the orifice) can be scratched or damaged due to impacting the mold components while being stripped off or ejected from the cores of the mold. The sealing surface is also subject to slight damage during the sorting and handling that occurs during the automatic assembly process of the closure, as well as the manipulation that occurs during filling and final assembly of the closure to the container. The scratching and damage that occurs can create a seal failure that is more severe when trying to hold a positive or negative pressure in the container.

### SUMMARY

The present application is related to closures for fluid containers and, more specifically, to closures having an open/close type spout and plug, where at least one of the sealing surfaces within the closure includes a more resilient material molded over a more rigid material, thereby improving the performance and consistency of the closure product. This application is relevant to both push/pull type spouts and to twist open/close spouts.

Accordingly, it is a first aspect of the invention to provide a closure for a container adapted to contain a liquid comprising: (a) a base adapted to be attached to an opening of a fluid container, the base including a conduit extending therethrough that is adapted to be in fluid communication with fluid contents of the fluid container when attached to the opening of the fluid container, and the base further including a spout guide defining at least a portion of the conduit and having an annular deck extending inwardly from an inner circumferential surface of the base, defining an orifice in fluid communication with the conduit; (b) a spout mounted to the spout guide for reciprocation between an open position and a closed position, the spout including a plug having a leading end adapted to allow fluid flow through the orifice when the spout is in the open position; and (c) a discrete sealing member coupled to at least one of the spout and the base, adapted to be at least partially displaced between the orifice and the plug to provide a fluidic seal therebetween when the spout is in the closed position.

It is a second aspect of the invention to provide valve adapted to be operatively coupled to a fluid container to facilitate selective fluid communication between an interior of the fluid container and an exterior environment, the valve comprising a polymeric valve seat, adapted to be operatively coupled to a fluid container, and to a polymeric valve body coupled to the polymeric valve seat having a plug, the polymeric valve body being operative to manipulate fluid flow through an aperture in the polymeric valve seat by moving the polymeric valve body with respect to the polymeric valve seat such that the plug is inserted into the aperture, and a resilient member mounted to at least one of the aperture of polymeric valve seat and the plug of the polymeric valve body characterized as being partially displaced and providing a fluidic seal between the plug and the aperture when the polymeric valve body is in the closed position.

It is a third aspect of the present invention to provide a closure for a fluid container comprising a male member and a female member collectively operative to manipulate a volumetric flow of fluid from a fluid source, where the male member comprising a plug at least partially covered by a cap that is more resilient than the plug, where the male member moves axially with respect to the female member, and where the female member includes an orifice therein adapted to selectively contact the cap of the male member such that the cap of the male member deforms in response to contact with the female member to provide a fluidic seal therebetween.

It is a fourth aspect of the present invention to provide a closure for a fluid container comprising a male member and a female member collectively operative to manipulate a volumetric flow of fluid from a fluid source, where the female member including a support structure having an annular shelf defining a first orifice and a sealing member molded to the support structure and occupying at least a portion of the first orifice to define a second orifice coaxial with the first orifice, where the sealing member is more resilient than the support structure, and where the male member including a plug adapted to selectively occupy the second orifice, where at least a portion of the sealing member deforms in response to contact with the plug to provide a fluidic seal therebetween.

It is a fifth aspect of the present invention to provide a method of molding a base mounted to a sealing member adapted to be operatively coupled to a spout to comprise a container closure and provide selective fluid communication between an interior of a fluid container and an exterior environment, the method comprising the steps of: (a) configuring and closing a mold having a first cavity negatively defining one of a base of a container closure having a conduit therethrough and a sealing member having a channel therethrough; (b) injecting a first material into the first cavity to mold at least one of the base and the sealing member; (c) cooling the mold and the first material to impart rigidity to at least one of the base and the sealing member; (d) configuring the mold with respect to the first material to define a second cavity adjacent to the first material, the second cavity negatively defining the other one of the base of the container closure and the sealing member; (e) injecting a second material into the second cavity to mold the other of the base and the sealing member; (f) cooling the mold and the second material to impart rigidity to the other of the base and the sealing member; (g) opening the mold; and (g) releasing from the mold the sealing member mounted to the base.

It is a sixth aspect of the present invention to provide a closure for a fluid container comprising: (a) a container fitting including a container receiver for coupling to a mouth of a container to fluidicly seal the container fitting to the container, the container receiver including a conduit therethrough that is in communication with a spout through which material previously within the container egresses from via at least one orifice; and (b) a lid that is repositionable between a closed position where the material is inhibited from egressing from the closure fitting via the at least one orifice, and an open position where the material is allowed to egress from the closure fitting via the at least one orifice, at least one of the lid and the container fitting including a visual indicator evidencing that the lid has at least one of not been repositioned from the closed position to the open position and been repositioned from the closed position to the open position.

### BRIEF DESCRIPTION OF THE DRAWINGS

FIG. 1 is a cross-sectional view of an exemplary embodiment of a closure in accordance with the present invention;

FIG. 2 is an elevational, perspective view of an underside of the spout of FIG. 1;

FIG. 3 is a cross-sectional view of the spout of FIG. 2;

FIG. 4 is a cross-sectional view of FIG. 1 where arrows have been added to show internal pressures on the closure;

FIG. 5 is a cross-sectional view of another exemplary embodiment of a closure in accordance with the present invention;

FIG. 6 is a cut-away perspective view of a base of the closure depicted in FIG. 5;

FIG. 7 is a cross-sectional view of a precursor to the spout of FIG. 1, shown in the molded position within a mold;

FIG. 8 is a cross-sectional view of a precursor to the spout guide of FIG. 5, shown in the molded position within a mold;

FIG. 9 is a cross-sectional view of the spout of FIG. 1, shown in the molded position within a mold;

FIG. 10 is a cross-sectional view of the spout guide of FIG. 5, shown in the molded position within a mold;

FIG. 11 is a cross-sectional view of a further exemplary embodiment of a closure in accordance with the present invention;

FIG. 12 is a cross-sectional view of FIG. 11 where arrows have been added to show internal pressures on the closure;

FIG. 13 is a cross-sectional view of an even further exemplary embodiment of a closure in accordance with the present invention;

FIG. 14 is a cross-sectional view of an alternate exemplary precursor to the spout guide as shown in FIG. 1, where the precursor is shown within a mold;

FIG. 15 is a cross-sectional view of an alternate exemplary spout guide to that shown in FIG. 1, where the spout guide is shown within a mold;

FIG. 16 is an elevated perspective view of an exemplary mold that may be used to fabricate one or more of the exemplary closures of the present invention;

FIG. 17 is an elevated perspective view of an alternate exemplary mold that may be used to fabricate one or more of the exemplary closures of the present invention;

### DETAILED DESCRIPTION

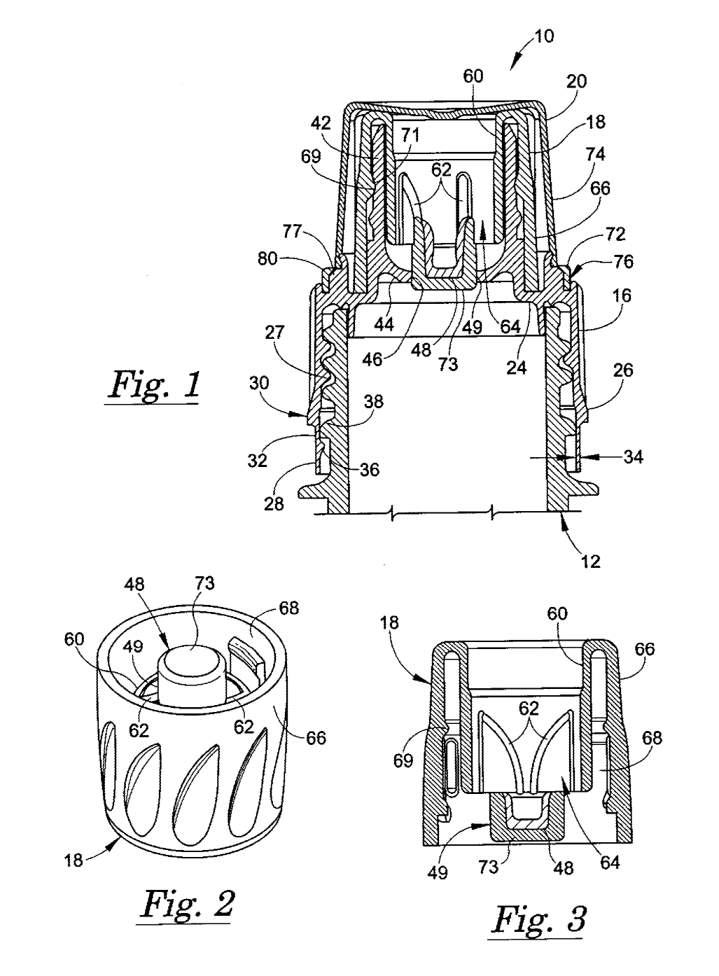

Referring to FIGS. 1-3, an exemplary closure 10, for use with a container 12, includes a base 16, a spout 18, and an overcap 20. The base 16 includes a generally cylindrical sidewall 26 including an internal helical thread 27 for threading the base 16 onto a throat of the container 12, an annular top wall 24 extending radially inward from the upper end portion of the sidewall, and an annular tamper band 28 extending from a lower end 30 of the sidewall 26. The tamper band 28 is attached to the side wall 26 with a plurality of bridges 32 formed by a cutting process subsequent to the molding process, resulting in the band 28 having a thickness 34 that is less than that of the sidewall 26 of the base 16. This reduced thickness provides the tamper band 28 with a certain degree of flexibility to facilitate application of the closure 10 onto the container 12 during the initial bottling operation. In this exemplary embodiment, the tamper band 28 includes a continuous annular bead 36 formed along the radially interior surface of the tamper band 28, or a plurality of individual beads 36 or protrusions that are circumferentially spaced apart along the interior radial surface of the tamper band 28. The inwardly extending bead(s) 36 cooperate with an outwardly extending annular bead 38 formed along the exterior radial surface of the container 12 to lock the tamper band 28 onto the container 12 during the initial bottling operation. When a consumer twists the base 16 counterclockwise with respect to the container 12 in order to remove the base from the container for the first time, the tamper band 28 permanently and visually separates from the base 16. The permanent separation results from the helical repositioning of the base 16 upward and away from the container 12 that causes the inwardly extending bead(s) 36 to abut the outwardly extending annular bead 38, which resists the upward movement of the inwardly extending bead(s) 36 and eventually breaking the plurality of bridges 32, leaving the tamper band 28 seated below the annular bead 38 on the container 12.

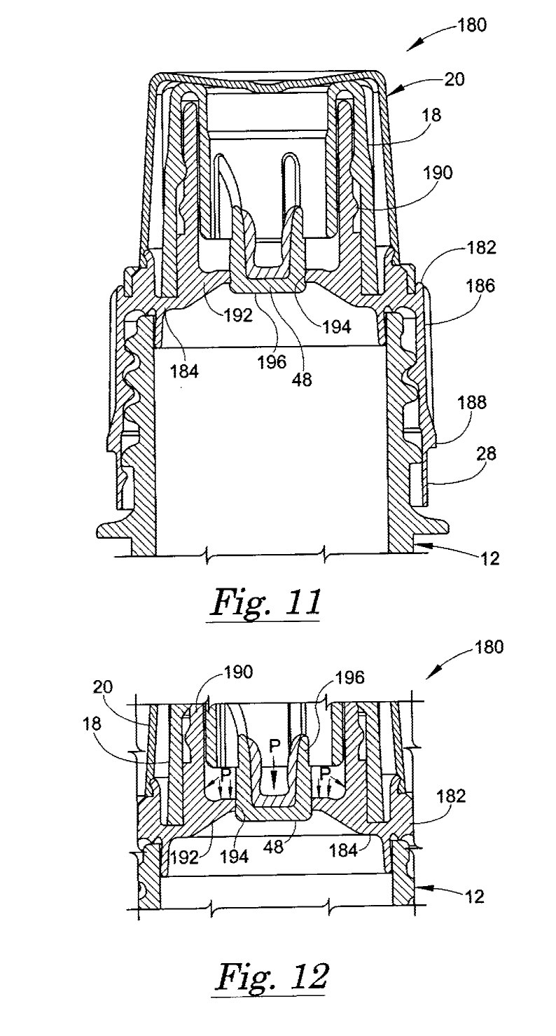

The base 16 also includes a tubular spout guide 42 extending coaxially upwardly from the top wall 24. The tubular spout guide 42 is provided with an inwardly extending annular deck 44 that defines a coaxial orifice 46 for receiving a plug 48 of the spout 18 when the spout is in its closed position as shown in FIG. 1. The deck 44 is substantially bowl shaped (i.e., concave) and extends generally downwardly from the interior surface of the tubular spout guide 42 near a lower end of the tubular spout guide 42 above the top wall 24 of the base 16. It is also within the scope of the invention that the deck 44 be substantially dome shaped (i.e., convex) as will be described further below (See FIG. 11).

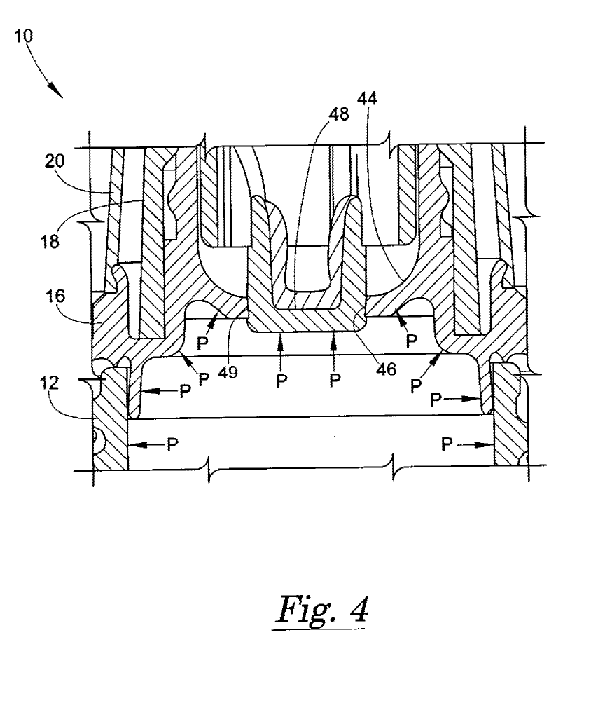

FIG. 4 illustrates internal pressure being applied to the plug 48, the deck 44, and the other interior exposed portions of the closure 10 (as illustrated by the arrows following letter P). When the contents of the container 12 are under a pressure greater than ambient atmospheric pressure, the contents will push against the lower surface of the deck 44. This pressure tends to direct the deck 44 more tightly against a circumferential sealing surface 49 of the plug 48, thus improving the seal between the deck 44 and the plug 48.

As will be understood by those skilled in the art, the thickness and angle of the deck 44 can vary widely to manipulate the extent of the deflection achievable for the purposes discussed herein. Typically, the thickness of the deck 44 will be in a range from about 0.025 inches to about 0.055 inches and may take into account the resiliency of the material utilized to construct the deck 44, the size of the tubular spout guide 42, and the distance from the orifice 46 to the tubular spout guide 42. For example, as the resiliency of the material decreases, the thickness of the deck 44 can decrease, and vice versa. In the exemplary embodiments, the angle of the deck 44 can vary from horizontal from about 8 degrees to about 30 degrees. However, deck 44 angles of greater than 30 degrees and approximating 90 degrees are also within the scope of the instant invention. In addition, as the deck 44 angle increases, thereby departing from horizontal and approaching vertical, the thickness of the deck can decrease, and vice versa.

Referring again to FIGS. 1-3, the spout 18 includes an outer cylindrical wall 66 and an inner cylindrical wall 60 from which two or more bridge(s) 62 extend radially inward to retain the plug 48 in a coaxial position. Openings 64 between bridges 62 provide at least one fluid flow passageway between the inner cylindrical wall 60 and the plug 48. Although the spout 18 of this exemplary embodiment is described as having at least two bridges 62 forming at least two fluid flow passageways, it should be understood that the spout 18 can be provided with only one bridge 62 and only one fluid flow passageway. In the instant embodiment, the bridges 62 are spaced apart from one another and can be arranged in any suitable configuration to form the fluid flow passageways. For example, the bridges 62 can extend radially or non-radially from the plug 48, randomly or in a suitable pattern.

A cylindrical cavity 68 is provided between the outer cylindrical wall 66 and the inner cylindrical wall 60 that receives the tubular spout guide 42 of the base 16. The outer cylindrical wall 66 includes an internal thread 69 for engagement with an external thread 71 of the spout guide 42. Thus, the spout 18 is received over the tubular spout guide 42 of the base 16 and is adapted to move between an open position (where the plug 48 is removed upwardly from the orifice 46) and a closed position (see FIG. 1) by rotation of the spout 18 relative to the tubular spout guide 42 along the helical threads 69/71. It is also within the scope of the invention to substitute a push-pull type of spout for the screw type spout 18.

A resilient cap 73 is molded over the end of the plug 48 and provides a circumferential resilient surface 49 that abuts and seals against the inner circumferential surface defining the orifice 46 in the deck 44 when the spout is in the closed position as shown in FIG. 1. To protect the circumferential resilient surface 49 against damage due to manufacturing and handling, the circumferential resilient surface 49 is axially (i.e., upwardly) recessed within the outer cylindrical wall 66 so that the seal surface 49 is protected from damage by the outer cylindrical wall 66. While the sidewall 66 of the exemplary embodiment extends downward beyond the plug 48 and protects the entire circumferential resilient surface 49, it is within the scope of the invention that the outer cylindrical wall 66 extend downward to protect less than the entire circumferential resilient surface 49 of the plug 48. In such an exemplary circumstance, the protected portion of the circumferential resilient surface 49 would provide the annular sealing surface that seals against the inner circumferential surface defining the orifice 46 in the deck 44. As discussed previously, this exemplary embodiment is amendable to be used with a push-pull type spout, and is also amendable to be used with various other types of open/close spout and plug configurations. In any such alternate exemplary embodiment, at least one of the surfaces creating the seal is composed of a resilient material.

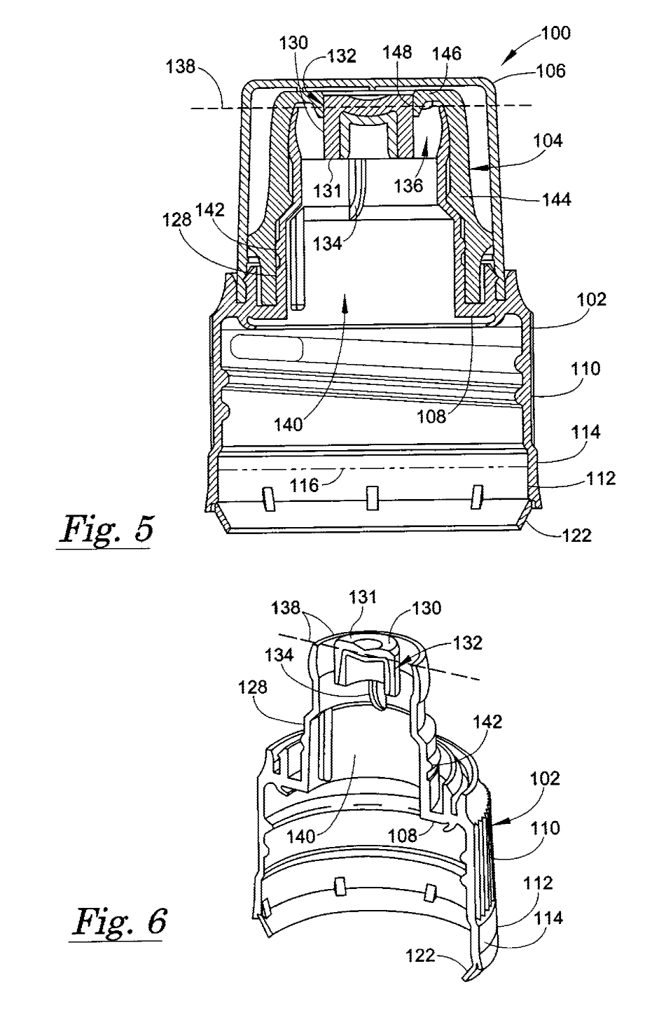

For example, as shown in FIGS. 5 and 6, an alternate exemplary embodiment of a closure 100 with an open/close spout and plug configuration is provided, where the sealing surface of the plug is protected. Specifically, the closure 100 is configured to be connected to a container (not shown), where the closure 100 itself includes a base 102, a spout 104, and an overcap 106.

The base 102, which is adapted to be threaded onto the container, includes a generally cylindrical sidewall 110, an annular top wall 108 extending radially inward from the upper end portion of the sidewall, and an annular tamper band 112 connected to a lower end 114 of the sidewall 110. The tamper band 112 is attached to the sidewall 110 with a plurality of bridges 116 formed by a cutting process subsequent to the molding process, or the bridges 116 may be formed by the molding process itself. The tamper band 112 is formed with a continuous bead 122 formed along the interior radial surface of the tamper band 112, or may instead include a plurality of beads or protrusions which are circumferentially spaced apart along the interior radial surface of the tamper band 112. The bead(s) 122 cooperate with an annular bead formed on the container to lock the tamper band 112 to the container.

The base 102 also includes a tubular spout guide 128 extending upward from the top wall 108, and a coaxial plug 130 having a resilient cap 131 molded over the end of the plug that provides a circumferential resilient surface 132. The plug 130 is connected to the tubular spout guide 128 with one or more bridge(s) 134, where the bridges are spaced to define one or more openings 136 through which fluid flows when the circumferential resilient surface 132 is not sealed against a deck 144 of the spout 104. Although the base 102 will be described hereinafter as having at least two bridges 134 partially defining at least two fluid flow passageways, it should be understood that the base 102 can be provided with only one bridge 134 and only one fluid flow passageway.

The tubular spout guide 128 defines a conduit 140 in fluid communication with the openings 136 so that fluid can flow through the conduit 140 and then through the openings 136 to egress from the container. The spout 104 is received over the tubular spout guide 128 of the base 102 and is adapted to move between an open position and a closed position by rotation of the spout 104 relative to the tubular spout guide 128 along a helical thread 142, however, the spout guide 128 can be adapted to accommodate a push-pull type spout. The spout 104 includes a substantially cylindrical body 144 having a radially inwardly extending deck 146 that defines an orifice 148.

The deck 146 is repositionable with respect to the plug 130 so that when the spout 104 is positioned in the closed position, at least a portion of the circumferential resilient surface 132 of the plug abuts the inner circumferential surface of the deck 146 that defines the orifice 148 and forms a seal to substantially prevent fluid from passing between the deck 146 and plug 130. In contrast, when the spout 104 and deck 146 are repositioned upward and away from the plug 130 to reach the open position, the seal is discontinued so that the circumferential resilient surface 132 of the plug no longer abuts the inner circumferential surface of the deck 146 that defines the orifice 148, thereby allowing fluid to pass between the plug 130 and the deck 144 and egress from the container. The plug 130 is supported by the bridges 134 so that at least a substantial portion of the circumferential resilient surface 132 of the plug 130 is positioned axially below an upper end 138 of the tubular spout guide 128 so that the tubular spout guide will protect the sealing portion of the circumferential resilient surface 132 from damage during manufacturing and handling.

With the above embodiments of FIGS. 1-3 and FIGS. 5-6, it is also advantageous that the circumferential resilient surfaces 49/132 are substantially cylindrical or frustroconical to reduce the chances that the plug will be damaged by the mold upon axial removal of the associated component (the spout component 18 in the embodiment of FIGS. 1-3 and the base component 102 in the embodiment of FIGS. 5-6) from the mold after molding is complete.

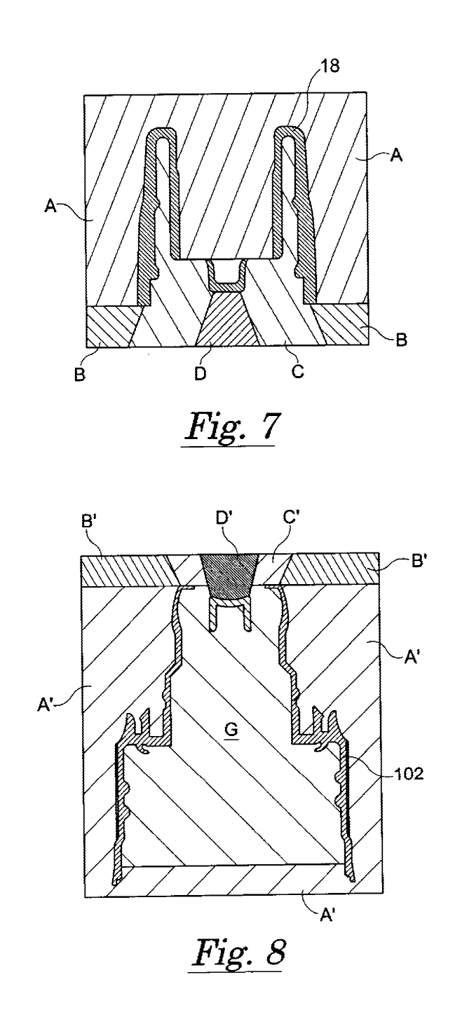

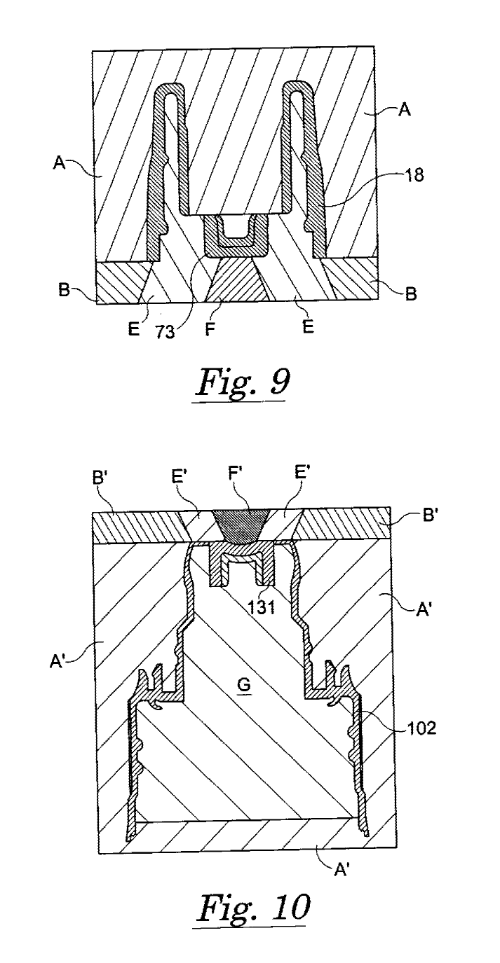

Referring to FIGS. 7 and 9, the exemplary the spout component 18 in the embodiment of FIGS. 1-3 may be fabricated using an injection molding process. For example, in FIG. 7, the entire spout component 18, less the resilient cap 73, is molded in a first step. Mold elements A, B, C, and D are positioned to define a cavity having dimensions characteristic of the spout component 18, less the cap 73. Mold element D includes a conduit (not shown) through which molten polymer enters and entirely fills the cavity. The polymer injected into the cavity is allowed to cool enough so that the mold elements C and D can be withdrawn, with the spout component being retained by mold elements A and B. Mold elements E and F are positioned with respect to mold elements A and B to define a second cavity having dimensions characteristic of the resilient cap 73 to be molded on the spout component 18 produced during the first step. Mold element F includes a conduit (not shown) through which molten polymer enters and entirely fills the cavity to overmold the resilient cap 73 onto the spout component 18 of the first step. The polymer injected into the cavity is allowed to cool enough so that the mold elements E and F can be withdrawn, and thereafter a finished spout component 18 is ejected from mold elements A and B.

Referencing FIGS. 8 and 10, an analogous process may be used to fabricate the base component 102 in the embodiment of FIGS. 5-6. In a first step, as shown in FIG. 8, the entire base component 102, less the resilient cap 131, is molded using mold elements A′, B′, C′, D′, and G. Mold element D′ includes a conduit (not shown) through which molten polymer enters and entirely fills the cavity to form the base component, less the cap 131. The polymer injected into the cavity is allowed to cool enough so that the mold elements C′ and D′ can be withdrawn, with the base component being retained by mold elements A and B. Mold elements E and F are positioned with respect to mold elements A′, B′, and G to define a second cavity having dimensions characteristic of the resilient cap 131 to be molded on the base component 102 produced during the first step. Mold element F′ includes a conduit (not shown) through which molten polymer enters and entirely fills the cavity to overmold the resilient cap 131 onto the base component 102 of the first step. The polymer injected into the cavity is allowed to cool enough so that the mold elements E′ and F′ can be withdrawn, and thereafter a finished spout component 18 is ejected from mold elements A′, B′ and G.

Referring to FIGS. 11 and 12, an alternate exemplary closure 180 includes a base 182, a spout 18, and an overcap 20. The base 182, which is adapted to be threaded onto a container 12, includes a generally cylindrical sidewall 186, an annular top wall 184 extending radially inward from the upper end portion of the sidewall 186, and an annular tamper band 28 connected to a lower end 188 of the sidewall 186.

The base 182 also includes a tubular spout guide 190 extending upwardly from the top wall 184 having a radially inwardly extending annular deck 192. An orifice 194 at the end of the annular deck 192 is adapted to receive a plug 48 of the spout 18 when the spout is in its closed position as shown in FIG. 12. The deck 192 is convex as it extends generally upward from the interior surface of the tubular spout guide 190 near a lower end of the tubular spout guide 190. When the plug 48 is moved downward and into contact with the deck 192, the angled nature of the deck resists the downward force applied by the plug 48 as the plug is wedged into the orifice 194. In this manner, downward deflection of the deck 192 caused by downward movement of the plug 48 forces the deck 192 tighter against the plug, thereby increasing the force necessary to breach the seal. This tightening effect can be increased by having tapered plugs 48 or a plug 48 that incorporates a ring or rim larger than the orifice 194 that would push downward against the deck 192 when the plug 48 is inserted into the orifice 194. Again, as in FIGS. 1-4, the plug 48 includes an overmolded resilient cover 196 against which the deck presses to form a seal therebetween.

As shown in FIG. 12, the ambient atmospheric pressure, represented by the arrows following letter P, will push downward upon the deck 192 when the contents within the container are at a pressure lower than ambient atmospheric pressure. An exemplary instance where such a pressure differential may exist is when high temperature liquids are introduced into the container and sealed while the contents are at an elevated temperature and ambient atmospheric pressure. As these liquids cool, the volume of the container is presumed fixed and therefore pressure must correspondingly drop with the temperature.

It is to be understood that the exemplary closure 180 may be fabricated using an injection molding process that fabricates the spout 18, less the resilient cover 196, in a first step, and thereafter molds the resilient cover 196 as part of the plug in a second step. Those of ordinary skill will readily understand the alternative molding techniques that may be utilized to fabricate the exemplary closures discussed herein. Moreover, the exemplary technique for molding the spout component 18 and the base component 102 discussed previously, is likewise applicable to mold the spout 18 of this closure 180.

The components of the closures 10, 100 and 180 can be formed by any suitable process capable of forming material into the various shapes or configurations either discussed above or shown in the attached drawings. For example, the closures 10, 100 and 180, can be constructed of one or more thermoplastic materials using an injection molding process or a compression molding process. By resilient, it is meant that the material may have more bounce back properties or ability to deform without destruction of the material properties. Various compounds can accomplish this, include TPE or TPV or any similar rubber/elastomer or other thermo-plastic elastomer which can be deformed yet maintain integrity and property construction and resiliency.

Similarly, the deck 44 can be constructed of any material having some flexibility and is manufacturable to the configurations shown in the drawings and discussed herein. For example, the base 16 can be constructed of a thermoplastic or UV curable material, such as polyethylene, polypropylene, polybutylene, or polyurethane. Those of ordinary skill are familiar with the various polymers which can be used to fabricate the instant invention. However, the instant invention is not limited to polymer substrates and may likewise be fabricated from metals, ceramics, and composite materials.

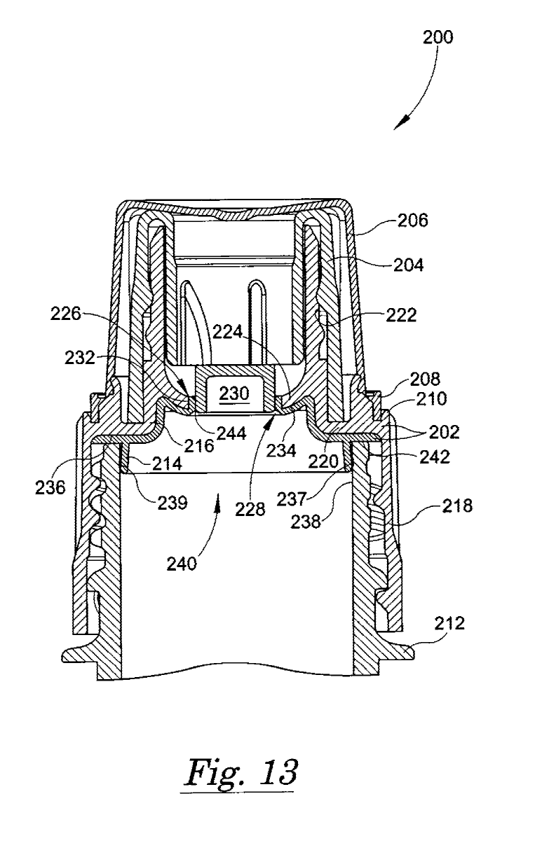

Referencing FIG. 13, a further exemplary embodiment of a closure 200 is constructed in accordance with at least certain aspects of the present invention. The closure 200 is similar in function to the closure 10 (FIGS. 1-3), except as discussed hereafter. The closure 200 is provided with a base 202, a spout 204, and an overcap 206. The overcap includes an annular tamper band 208 connected to an upper end 210 of the base 202. The base 202 is adapted to be threaded onto a container 212 and generally comprises two constituents, a resilient annular seal member 214 and a more rigid frame structure 216.

The frame structure 216 includes a generally cylindrical sidewall 218 and an annular top wall 220 extending radially inward from the upper end portion of the sidewall. The frame structure 216 further includes a tubular spout guide 222 extending upwardly from the top wall 220. The tubular spout guide 222 is provided with a radially inwardly extending annular deck 224 at its lower end that provides a coaxial orifice 226 for seating the annular seal member 214 that defines a second, smaller diameter coaxial orifice 228 adapted to receive a plug 230 of the spout 204 when the spout is in its closed position as shown in FIG. 13. The deck 224 is concave as it extends generally downwardly from the interior surface of the tubular spout guide 222 near a lower end of the tubular spout guide 222.

The seal member 214 is substantially annular and is molded over (as otherwise coupled to) an interior surface 232 of the coaxial orifice 226, a downward facing surface 234 of the annular deck 224, and a downward facing surface 236 of the annular top wall 220. The annular seal member 214 includes a coaxial, substantially cylindrical projection 237 extending downwardly therefrom and is adapted to provide a seal against the inner circumferential surface 230 of the container's throat 240. The projection 237 includes an annular rib 239 on an outer circumferential surface of the projection 237, where the annular rib 239 has an outer diameter that is slightly larger than an inner diameter of the container's throat 240 such that the projection 237 must deflect radially inwardly as the closure 200 is threaded onto the container 212, thereby forming an annular seal between the annular rib 239 and the inner circumferential surface 238 of the throat 240. Further, as the closure 200 is fitted onto the container 212 the seal member 214 provides a bushing between the frame structure 216 and a top circumferential surface 242 of the throat 240.

The annular plug-seal portion 228 of the seal member 214 is molded coaxially about the radially inner surface of the orifice 226 of the frame structure 216 and provides an annular seal 244 against the outer circumferential surface of the plug 230 when the plug is received within the orifice 226. This annular plug-seal portion 229 has an inner diameter that is slightly smaller than the outer diameter of the plug 230 so that the plug-seal portion 228 must deflect slightly as the plug 230 is inserted into the orifice 226, thereby providing a fluidic seal thereabout.

It is also within the scope and spirit of the present invention to manipulate the geometries of the deck and plug with respect to one another, such as having the plug embody a conical shape and the deck be beveled accordingly to accept such a plug. It is further within the scope and spirit of the present invention for the seal member 214 to extend along an interior portion of the spout guide 222 (see FIG. 15)

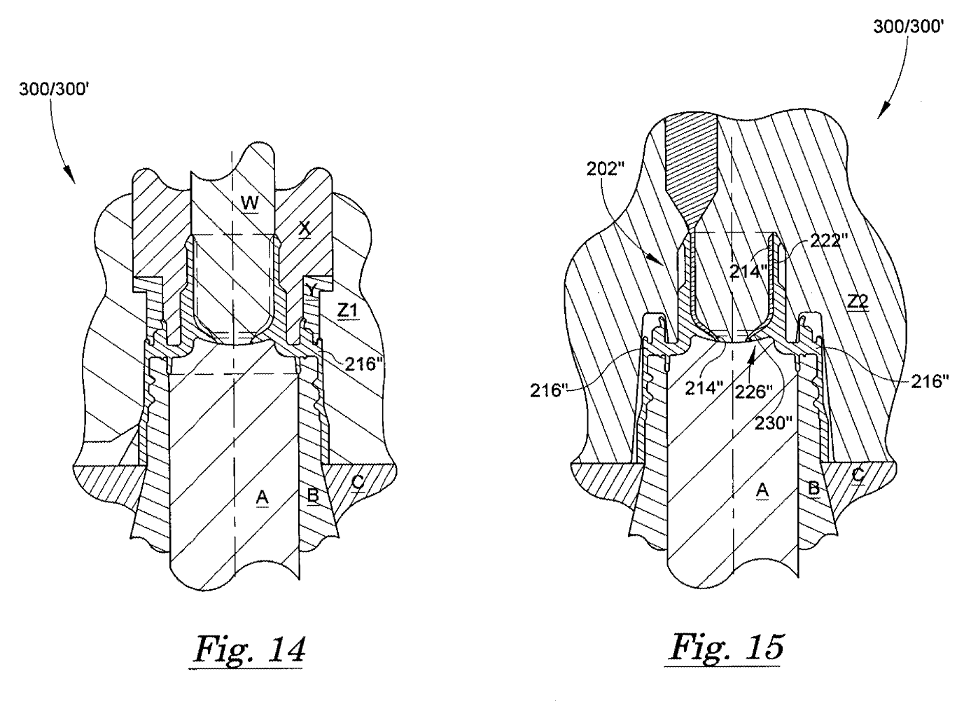

Referencing FIGS. 14-17, an exemplary method of manufacturing a closure may include a two-step fabrication process to produce a base 202″. An exemplary molding technique, injection molding, will be discussed for purposes of explanation. However, it is to be understood that alternate manufacturing techniques currently available and hereafter arising shall fall within the scope and spirit of the invention.

To fabricate the base 202″, as shown in FIG. 14, a series of elements A, B, C, W, X, Y, Z1 of a mold 300, 300′ are configured to negatively define a first cavity utilized to form a frame structure 216″. The mold is heated and a molten, first polymer material is injected into the first cavity. After the first polymer material has sufficiently filled the first cavity, the inflow of material ceases and the mold is cooled to bring the first polymer material to a semi-rigid state, thereby forming the frame structure 216″ (A semi-rigid state refers to the materials ability to retard deformation). As shown in FIG. 15, the mold is then reconfigured to remove elements W, X, Y, Z1 and substitute element Z2 in place thereof to negatively define a second cavity utilized to mold a seal member 214″ onto the frame structure 216″. A second, more resilient polymer material is injected into the second cavity to sufficiently fill the cavity and bond the resilient polymer material to the interior surface 230″ of the coaxial orifice 226″ and the interior wall of the tubular spout guide 222″. The mold 300, 300′ is cooled, opened, and thereafter the molded base 202″ is ejected from the mold.

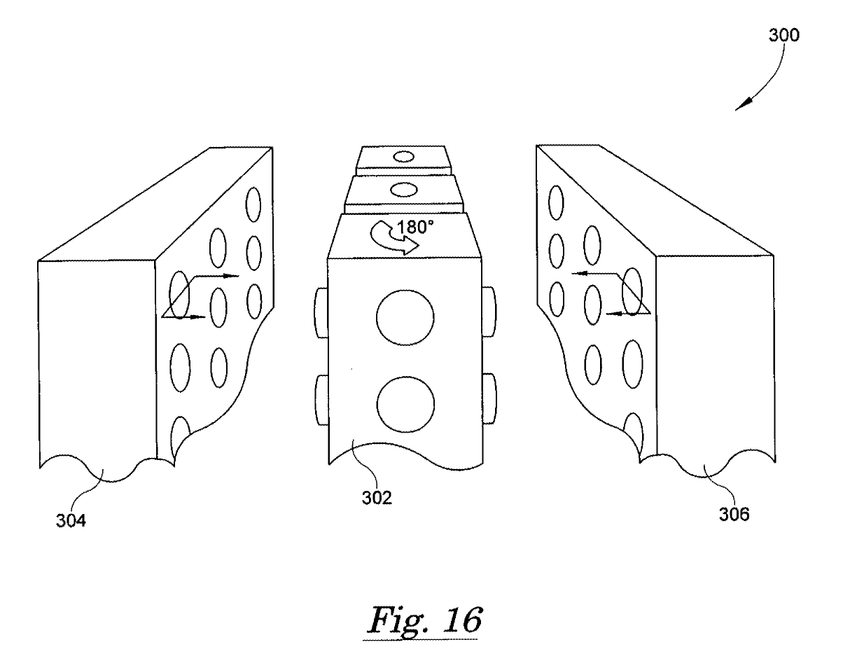

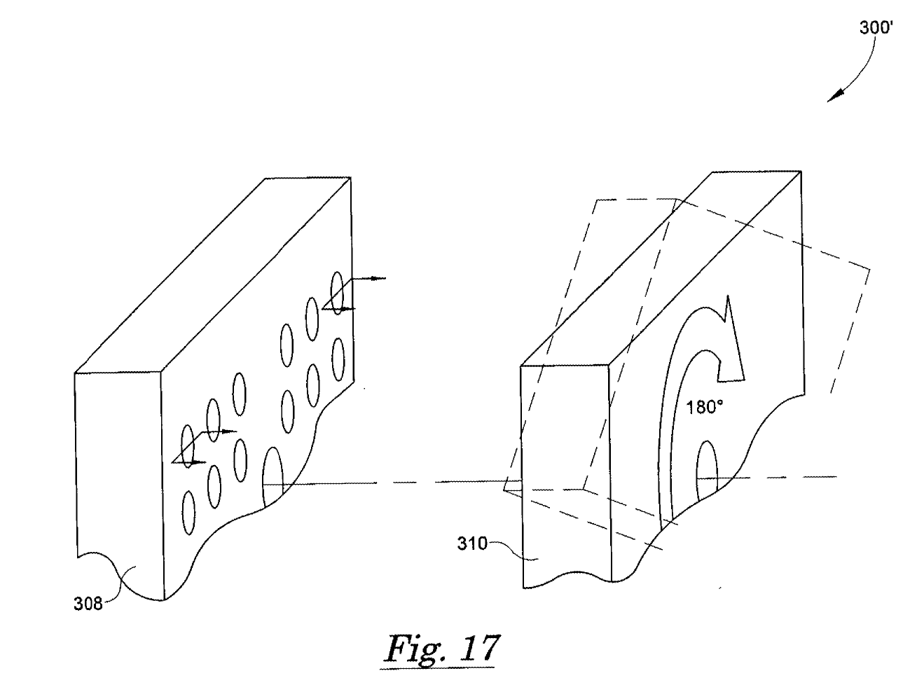

As shown in FIG. 16, in a first exemplary mold configuration, the mold 300 may include one or more carriers 302 that rotate between steps of the molding process. In a first step, a first section 304 of the mold 300 partially defines the first cavity corresponding to the frame structure 216″. The carrier 302 and the first section are closed and the frame section 216″ is molded onto the carrier 302. The first section 304 thereafter opens, leaving the frame structure 216″ coupled to the carrier 302. In a second step, the carrier rotates 90 degrees having the frame structure 216″ still coupled thereto. In a third step, the carrier 302 rotates another 90 degrees and directs the frame structure 216″ into the second cavity partially defined by a second section 306 of the mold. The second section 306 of the mold closes with respect to the carrier 302 and the seal member 214″ is molded onto the frame structure 216″. In a fourth step, the carrier rotates another 90 degrees and ejects the finished base 202″ therefrom and prepares to start the sequence of steps again. As shown in FIG. 16, the first section 304, carriers 302, and second section 306 of the mold 300 may include the capability to mold more than one base 202″ during the above sequence of steps. The above sequence of steps may also be performed concurrently with respect to different bases 202″ or unfinished components thereof 214″, 216″.

As shown in FIG. 17, in a second exemplary mold configuration, the mold 300′ is divided into two halves 308, 310, with the first half 308 being divided into a right hand side 312 that includes cavities for molding frame structures 216″, and a left hand side 314 includes cavities for molding seal members 214″ onto frame structures 216″. In this exemplary embodiment, the carrier is effectively integrated into the second half 310 that rotates 180 degrees to alternate between molding the frame structure 216″ and molding the seal member 214″ onto the frame structure 216″. In such an exemplary molding process, the mold 300′ is closed to mold the frame structure 216″ onto the carrier 310 in a first step. The mold 300′ opens and the frame structure 216″ is retained by the carrier 310. In a second step, the carrier 310 is rotated 180 degrees and the mold 300′ is closed to mold the seal member 214″ onto the frame structure 216″. Thereafter, the mold 300′ is opened and the finished base 202″ is ejected from the carrier 310 and the carrier is repositioned to begin the first step again.

Alternatively, a mold may allow reconfiguration to be carried out without necessitating opening the mold. Such a mold would include internal elements that are repositionable to selectively define the respective cavities necessary to mold the seal member 214″ and the frame structure 216″. Such internally reconfigurable molds are known to those of ordinary skill in the art.

The exemplary closures of the present invention are used in a similar manner, and thus, reference will be had to the closure 10 of FIG. 1 for such an explanation of use for purposes of brevity. The container 12 is filled with a fluid, such as a liquid, a gas, or some combination of the two, such as a carbonated or non-carbonated beverage via processes known in the art. Thereafter, the closure 10 is connected or applied to the container 12 in any suitable manner, such as by screwing the sidewall 26 to the container 12 while the closure 10 is in the closed position. The container 12 having the closure 10 applied thereto and sealing the fluid in the container 12 can then be shipped to a retail location, such as a store or an automated dispensing machine. A consumer purchases the container 12 having the closure 10, and then initially removes the overcap 20 (leaving the tamper band 72 within the annular groove 76 in the base 16 as discussed above). The spout 18 is then moved to the open position, such as by twisting the spout 18 along the helical thread, or moving the spout 18 either upwardly or downwardly in a linear fashion. The consumer then either drinks from the spout 18 and/or pours the fluid out of the spout 18 and into a cup. To reseal the container 12, the spout 18 is moved to the closed position. The overcap 20 can then be reapplied to the base 16 to cover or protect the spout 18, where the visible gap 82 between the overcap 20 and the tamper band 72 indicates that the overcap has been removed at least once.

The materials used in the formation of the base 16 and the spout 18 can vary widely depending upon the desired application of the closure 10. In an exemplary embodiment, the base 16 and the spout 18 are constructed of different materials to avoid cohesive bonding which can occur between similar materials. For example, the base 16 can be constructed of polyethylene and the spout 18 can be constructed of polypropylene.

The base 16 and the spout 18 are typically formed as separate components which are interconnected to form the closure 10 by an automated assembling machine.

The closures 10, 100 and 180 can be used as a liner-less closure for the container 12. The container can be filed with the fluid by any suitable process, such as a hot fill process, an ambient fill process, or an aseptic process and the closures 10, 100 and 180 can be applied to the container 12 by a conventional closure applicating machine. The fluid can be a beverage having a high sugar content, such as tea or juice, or beverages rich in mineral salts, such as an isotonic beverage.

The pressure maintained within the container 12 by the closures 10, 100 and 180 can vary widely. For example, the fluid may be a non-carbonated or low carbonated beverage such that the pressure within the container 12 is less than about 110 lbs/in² and typically in the vicinity of about 30 lbs/in². Positive pressure can be added to the container 12 by inserting liquid nitrogen into the container 12 and then immediately applying the closures 10, 100 or 180 to the container 12. The closures 10, 100 and 180 can be repeatedly opened and closed.

As an example, the closures 10, 100 and 180 can serve as liner-less closures for a container 12 that has been filled with a hot-fill process. In the hot-fill process, the medium is heated in the vicinity of about 180° F.-190° F. to kill any bacteria present in the medium. The container 12 is then filled with the heated medium and the closure 10, 100 or 180 is applied immediately while the medium is still hot. The container 12 is then immediately cooled by any manner known in the art, such as by passage of the container 12 through a cold water bath. As the medium cools, a negative gauge pressure will result within the container 12 and be maintained by the closure. When the closures 10, 100 and 180 are used during the hot-fill process, the closures will typically be constructed of a heat resistant material. For example, the base can be constructed of polypropylene, and the spout can be constructed of polyethylene.

As another example, the closures 10, 100 and 180 can be used for closing containers 12 filled by an aseptic process. In the aseptic process, the medium is heated in the vicinity of about 180° F.-190° F. to kill any bacteria present in the medium. The medium is then cooled in the vicinity of about 80° F.-90° F. The container 12 and the closures 10, 100 and 180 are sterilized and then the containers 12 are filled and capped in a sterile environment. Once the containers 12 are filled and capped, such containers typically cool to room temperature thereby creating a negative gauge pressure, e.g. −2 lbs/in² within the containers 12.

Following from the above description and invention summaries, it should be apparent to those of ordinary skill in the art that, while the apparatuses herein described and illustrated constitute exemplary embodiments of the present inventions, it is understood that the inventions are not limited to these precise embodiments and that changes may be made therein without departing from the scope of the inventions as defined by the claims. Additionally, it is to be understood that the inventions are defined by the claims and it is not intended that any limitations or elements describing the exemplary embodiments set forth herein are to be incorporated into the meanings of the claims unless explicitly recited in the claims themselves. Likewise, it is to be understood that it is not necessary to meet any or all of the recited advantages or objects of the inventions disclosed herein in order to fall within the scope of any claim, since the inventions are defined by the claims and since inherent and/or unforeseen advantages of the present inventions may exist even though they may not have been explicitly discussed herein.

What is claimed is:

1. A closure for a container adapted to contain a liquid comprising:
a base adapted to be attached to an opening of a fluid container, the base including a conduit extending therethrough that is adapted to be in fluid communication with fluid contents of the fluid container when attached to the opening of the fluid container, and the base further including a spout guide defining at least a portion of the conduit and having an annular deck extending inwardly from an inner circumferential surface of the base, defining an orifice in fluid communication with the conduit;
a spout mounted to the spout guide for reciprocation between an open position and a closed position, the spout including a plug having a leading end adapted to allow fluid flow through the orifice when the spout is in the open position; and
a discrete sealing member coupled to at least one of the spout and the base, adapted to be at least partially displaced between the orifice and the plug to provide a fluidic seal therebetween when the spout is in the closed position.

2. The closure of claim 1, wherein:
the orifice is circular; and
the discrete sealing member is annular and coupled to the leading end of the plug.

3. The closure of claim 1, wherein the discrete sealing member is formed for a material that includes at least one of polyethylene, polypropylene, polyurethane, polybutylene and thermoplastic elastomer.

4. The closure of claim 1, wherein an inner circumferential surface of the orifice is beveled.

5. The closure of claim 1, wherein the plug is at least one of conical or frustraconical.

6. The closure of claim 1, wherein:
the discrete sealing member is coupled to the plug;
the discrete sealing member comprises a first material and the spout comprises a second material; and
the first material is more resilient than the second material.

7. The closure of claim 1, wherein the discrete sealing member is mounted onto the plug of the spout.

8. The closure of claim 1, wherein:
the discrete sealing member is coupled to the annular deck of the base about the orifice;
the discrete sealing member comprises a first material and the annular deck comprises a second material; and
the first material is more resilient than the second material.

9. The closure of claim 8, wherein the discrete sealing member is molded onto the base.

10. The closure of claim 8, wherein the discrete sealing member is adapted to seal against at least a first surface of the annular deck when the spout is in the open position and seal against at least a second surfaces of the spout when the spout is in the closed position.

11. The closure of claim 10, wherein the plug is at least one of conical or frustraconical.

12. The closure of claim 1, wherein the discrete sealing member is coupled to the base and includes a dual flange such that a first flange forms a first circumferential seal between the base and the fluid container and a second flange forms a second circumferential seal with an interior wall of the fluid container to direct a fluid from the fluid container through the orifice.

13. The closure of claim 12, wherein:
a first surface of the discrete sealing member is coupled to a receiving surface of the base; and
the first surface generally tracks a topography of at least a portion of the receiving surface.

14. The closure of claim 13, wherein:
the receiving surface includes a step transitioning into the annular deck;
the first surface circumferentially lines the inner circumferential surface orifice and includes an exterior surface adapted to interface the plug to seal off the orifice; and
the exterior surface adapted to interface the plug is non-planar.

15. A valve adapted to be operatively coupled to a fluid container to facilitate selective fluid communication between an interior of the fluid container and an exterior environment, the valve comprising:
a polymeric valve seat, adapted to be operatively coupled to a fluid container, and to a polymeric valve body coupled to the polymeric valve seat having a plug, the polymeric valve body being operative to manipulate fluid flow through an aperture in the polymeric valve seat by moving the polymeric valve body with respect to the polymeric valve seat such that the plug is inserted into the aperture, and a resilient member mounted to at least one of the aperture of polymeric valve seat and the plug of the polymeric valve body characterized as being partially displaced and providing a fluidic seal between the plug and the aperture when the polymeric valve body is in the closed position.

16. The valve of claim 15, wherein the resilient member is mounted about the aperture in the polymeric valve seat.

17. The valve of claim 15, wherein the resilient member is mounted about the plug.

18. The valve of claim 15, wherein the resilient member includes at least one of polyethylene, polypropylene, polyurethane, polybutylene and thermoplastic elastomer.

19. The valve of claim 15, wherein the resilient member is molded onto the polymeric valve seat.

20. The valve of claim 15, wherein the resilient member is molded onto the polymeric valve body.

21. The valve of claim 15, wherein the polymeric valve body includes a cylindrical actuator coupled to the plug to reposition the plug relative to the aperture, wherein the cylindrical actuator is threaded onto the valve seat such that the valve seat is tortuously actuated.

22. A closure for a fluid container comprising:
a male member and a female member collectively operative to manipulate a volumetric flow of fluid from a fluid source;
the male member comprising a plug at least partially covered by a cap that is more resilient than the plug, wherein the male member moves axially with respect to the female member; and
the female member includes an orifice therein adapted to selectively contact the cap of the male member such that the cap of the male member deforms in response to contact with the female member to provide a fluidic seal therebetween.

23. A closure for a fluid container comprising:
a male member and a female member collectively operative to manipulate a volumetric flow of fluid from a fluid source;
the female member including a support structure having an annular shelf defining a first orifice and a sealing member molded to the support structure and occupying at least a portion of the first orifice to define a second orifice coaxial with the first orifice, where the sealing member is more resilient than the support structure; and
the male member including a plug adapted to selectively occupy the second orifice, wherein at least a portion of the sealing member deforms in response to contact with the plug to provide a fluidic seal therebetween.

24. A method of molding a base mounted to a sealing member adapted to be operatively coupled to a spout to comprise a container closure and provide selective fluid communication between an interior of a fluid container and an exterior environment, the method comprising the steps of:
configuring and closing a mold having a first cavity negatively defining one of a base of a container closure having a conduit therethrough and a sealing member having a channel therethrough;
injecting a first material into the first cavity to mold at least one of the base and the sealing member;
cooling the mold and the first material to impart rigidity to at least one of the base and the sealing member;
configuring the mold with respect to the first material to define a second cavity adjacent to the first material, the second cavity negatively defining the other one of the base of the container closure and the sealing member;
injecting a second material into the second cavity to mold the other of the base and the sealing member;
cooling the mold and the second material to impart rigidity to the other of the base and the sealing member;
opening the mold; and
releasing from the mold the sealing member mounted to the base.

25. The method of claim 24, wherein the mold transitions from defining the first cavity to defining the second cavity without completely opening.

26. The method of claim 24, wherein the sealing member is molded in the first cavity and the base is molded in the second cavity.

27. The method of claim 24, wherein the base is molded in the first cavity and the sealing member is molded in the second cavity.

28. A method of molding a spout mounted to a sealing member adapted to be operatively coupled to a base to comprise a container closure and provide selective fluid communication between an interior of a fluid container and an exterior environment, the method comprising the steps of:
configuring and closing a mold having a first cavity negatively defining one of a sealing member and a spout of a container closure having a plug;
injecting a first material into the first cavity to mold at least one of the spout and the sealing member;
cooling the mold and the first material to impart rigidity to at least one of the spout and the sealing member;
configuring the mold with respect to the first material to define a second cavity adjacent to the first material, the second cavity negatively defining the other one of the spout of the container closure and the sealing member;
injecting a second material into the second cavity to mold the other of the spout and the sealing member;
cooling the mold and the second material to impart rigidity to the other of the spout and the sealing member;
opening the mold; and
releasing from the mold the sealing member mounted to the spout.

29. The method of claim 28, wherein the sealing member is molded in the first cavity and the spout is molded in the second cavity.

30. The method of claim 28, wherein the spout is molded in the first cavity and the sealing member is molded in the second cavity.

31. The method of claim 28, wherein the mold transitions from defining the first cavity to defining the second cavity without completely opening.

32. A multiple layer beverage closure, comprising:
a base affixed to a container and having an upwardly extending tubular spout guide and an annular deck, said deck having a aperture;
an annular spout vertically movable on said spout guide of said base and having an internally aligned plug, said plug aligned with said aperture in said deck and sealingly movable therein;
said plug having at least two layers, an inner layer being a first material, and an outer layer forming a resilient overmolded surface, said outer layer being separate and definable from said inner layer, said outer layer being more resilient than said inner layer.

33. The closure of claim 32 wherein said outer layer is a thermoplastic elastomer.

34. A multiple layer beverage closure, comprising:
a base affixed to a container and having an upwardly extending tubular spout guide and an annular deck, said deck having a aperture and being formed of a first material and a second resilient material, both said first and said second material forming an aligned aperture;
an annular spout vertically movable on said spout guide of said base and having an internally aligned plug, said plug aligned with said aligned aperture in said deck and sealingly movable therein;
said deck having at least two layers, a sealing layer being a first resilient overmolded material, and an upper layer, said sealing layer being separate and definable from said upper layer, said sealing layer being more resilient than said upper layer.

35. The closure of claim 34 wherein said sealing layer of said deck is a thermoplastic elastomer.
